(19) United States
(12) Patent Application Publication
(10) Pub. No.: US 2023/0401364 A1
(43) Pub. Date: Dec. 14, 2023

(54) AGENT MAP GENERATION

(71) Applicant: Hewlett-Packard Development Company, L.P., Spring, TX (US)

(72) Inventors: SUNIL KOTHARI, PALO ALTO, CA (US); LEI CHEN, PALO ALTO, CA (US); JACOB TYLER WRIGHT, SAN DIEGO, CA (US); MARIA FABIOLA LEYVA MENDIVIL, GUADALAJARA (MX); JUN ZENG, PALO ALTO, CA (US)

(21) Appl. No.: 18/033,289

(22) PCT Filed: Oct. 23, 2020
(86) PCT No.: PCT/US2020/057031

§ 371 Date: Apr. 21, 2023

(51) Int. Cl. G06F 30/27

(52) U.S. Cl. CPC G06F 30/27; G06F 2113/10

(57) ABSTRACT

Examples of apparatuses for agent map generation are described. In some examples, an apparatus includes a memory to store a layer image. In some examples, the apparatus includes a processor coupled to the memory. In some examples, the processor is to generate, using a machine learning model, an agent map based on the layer image.

### BACKGROUND

Three-dimensional (3D) solid objects may be produced from a digital model using additive manufacturing. Additive manufacturing may be used in rapid prototyping, mold generation, mold master generation, and short-run manufacturing. Additive manufacturing involves the application of successive layers of build material. In some additive manufacturing techniques, the build material may be cured or fused.

### BRIEF DESCRIPTION OF THE DRAWINGS

FIG. 1 is a flow diagram illustrating an example of a method for agent map determination;

FIG. 2 is a block diagram illustrating examples of functions for agent map generation;

FIG. 3 is a block diagram of an example of an apparatus that may be used in agent map generation;

FIG. 4 is a block diagram illustrating an example of a computer-readable medium for agent map generation;

FIG. 5 is a diagram illustrating an example of training;

FIG. 6 is a diagram illustrating an example of a machine learning model architecture; and

FIG. 7 is a diagram illustrating an example of a perimeter mask in accordance with some of the techniques described herein.

### DETAILED DESCRIPTION

Additive manufacturing may be used to manufacture three-dimensional (3D) objects. 3D printing is an example of additive manufacturing. Some examples of 3D printing may selectively deposit agents (e.g., droplets) at a pixel level to enable control over voxel-level energy deposition. For instance, thermal energy may be projected over material in a build area, where a phase change (for example, melting and solidification) in the material may occur depending on the voxels where the agents are deposited. Examples of agents include fusing agent and detailing agent. A fusing agent is an agent that causes material to fuse when exposed to energy. A detailing agent is an agent that reduces or prevents fusing.

A voxel is a representation of a location in a 3D space. For example, a voxel may represent a volume or component of a 3D space. For instance, a voxel may represent a volume that is a subset of the 3D space. In some examples, voxels may be arranged on a 3D grid. For instance, a voxel may be rectangular or cubic in shape. Examples of a voxel size dimension may include 25.4 millimeters (mm)/150≈170 microns for 150 dots per inch (DPI), 490 microns for 50 DPI, 2 mm, etc. A set of voxels may be utilized to represent a build volume.

A build volume is a volume in which an object or objects may be manufactured. A “build” may refer to an instance of 3D manufacturing. For instance, a build may specify the location(s) of object(s) in the build volume. A layer is a portion of a build. For example, a layer may be a cross section (e.g., two-dimensional (2D) cross section) of a build. In some examples, a layer may refer to a horizontal portion (e.g., plane) of a build volume. In some examples, an “object” may refer to an area and/or volume in a layer and/or build indicated for forming an object. A slice may be a portion of a build. For example, a build may undergo slicing, which may extract a slice or slices from the build. A slice may represent a cross section of the build. A slice may have a thickness. In some examples, a slice may correspond to a layer.

Fusing agent and/or detailing agent may be used in 3D manufacturing (e.g., Multi Jet Fusion (MJF)) to provide selectivity to fuse objects and/or ensure accurate geometry. For example, fusing agent may be used to absorb lamp energy, which may cause material to fuse in locations where the fusing agent is applied. Detailing agent may be used to modulate fusing by providing a cooling effect at the interface between an object and material (e.g., powder). Detailing agent may be used for interior features (e.g., holes), corners, and/or thin boundaries. An amount or amounts of agent (e.g., fusing agent and/or detailing agent) and/or a location or locations of agent (e.g., fusing agent and/or detailing) may be determined for manufacturing an object or objects. For instance, an agent map may be determined. An agent map is data (e.g., an image) that indicates a location or locations to apply agent. For instance, an agent map may be utilized to control an agent applicator (e.g., nozzle(s), print head(s), etc.) to apply agent to material for manufacturing. In some examples, an agent map may be a two-dimensional (2D) array of values indicating a location or locations for placing agent on a layer of material.

In some approaches, determining agent placement may be based on various factors and functions. Due to computational complexity, determining agent placement may use a relatively large amount of resources and/or take a relatively long period of time. Some examples of the techniques described herein may be helpful to accelerate agent placement determination. For instance, machine learning techniques may be utilized to determine agent placement.

Machine learning is a technique where a machine learning model is trained to perform a task or tasks based on a set of examples (e.g., data). Training a machine learning model may include determining weights corresponding to structures of the machine learning model. Artificial neural networks are a kind of machine learning model that are structured with nodes, model layers, and/or connections. Deep learning is a kind of machine learning that utilizes multiple layers. A deep neural network is a neural network that utilizes deep learning.

Examples of neural networks include convolutional neural networks (CNNs) (e.g., basic CNN, deconvolutional neural network, inception module, residual neural network, etc.) and recurrent neural networks (RNNs) (e.g., basic RNN, multi-layer RNN, bi-directional RNN, fused RNN, clockwork RNN, etc.). Some approaches may utilize a variant or variants of RNN (e.g., Long Short Term Memory Unit (LSTM), convolutional LSTM (Conv-LSTM), peephole LSTM, no input gate (NIG), no forget gate (NFG), no output gate (NOG), no input activation function (NIAF), no output activation function (NOAF), no peepholes (NP), coupled input and forget gate (CIFG), full gate recurrence (FGR), gated recurrent unit (GRU), etc.). Different depths of a neural network or neural networks may be utilized in accordance with some examples of the techniques described herein.

In some examples of the techniques described herein, deep learning may be utilized to accelerate agent placement determination. Some examples may perform procedures in parallel using a graphics processing unit (GPU) or GPUs. In some examples, a build with approximately 4700 layers may be processed with a GPU to generate fusing agent maps and detailing agent maps at 18.75 dots per inch (DPI) with 80 micrometer (μm) slices in 6 mins (or approximately 10 milliseconds (ms) per layer for fusing agent maps and detailing agent maps). Some examples of the techniques described herein may include deep learning techniques based on a convolutional recurrent neural network to map spatio-temporal relationships used in determining fusing agent maps and/or detailing agent maps. For example, a machine learning model (e.g., deep learning model) may be utilized to map a slice (e.g., slice image) to a fusing agent map and a detailing agent map. In some examples, an agent map may be expressed as a continuous tone (contone) image.

While plastics (e.g., polymers) may be utilized as a way to illustrate some of the approaches described herein, some the techniques described herein may be utilized in various examples of additive manufacturing. For instance, some examples may be utilized for plastics, polymers, semi-crystalline materials, metals, etc. Some additive manufacturing techniques may be powder-based and driven by powder fusion. Some examples of the approaches described herein may be applied to area-based powder bed fusion-based additive manufacturing, such as Stereolithography (SLA), Multi Jet Fusion (MJF), Metal Jet Fusion, Selective Laser Melting (SLM), Selective Laser Sintering (SLS), liquid resin-based printing, etc. Some examples of the approaches described herein may be applied to additive manufacturing where agents carried by droplets are utilized for voxel-level thermal modulation.

In some examples, “powder” may indicate or correspond to particles. In some examples, an object may indicate or correspond to a location (e.g., area, space, etc.) where particles are to be sintered, melted, or solidified. For example, an object may be formed from sintered or melted powder.

Throughout the drawings, identical or similar reference numbers may designate similar elements and/or may or may not indicate identical elements. When an element is referred to without a reference number, this may refer to the element generally, and/or may or may not refer to the element in relation to any Figure. The figures may or may not be to scale, and the size of some parts may be exaggerated to more clearly illustrate the example shown. Moreover, the drawings provide examples in accordance with the description; however, the description is not limited to the examples provided in the drawings.

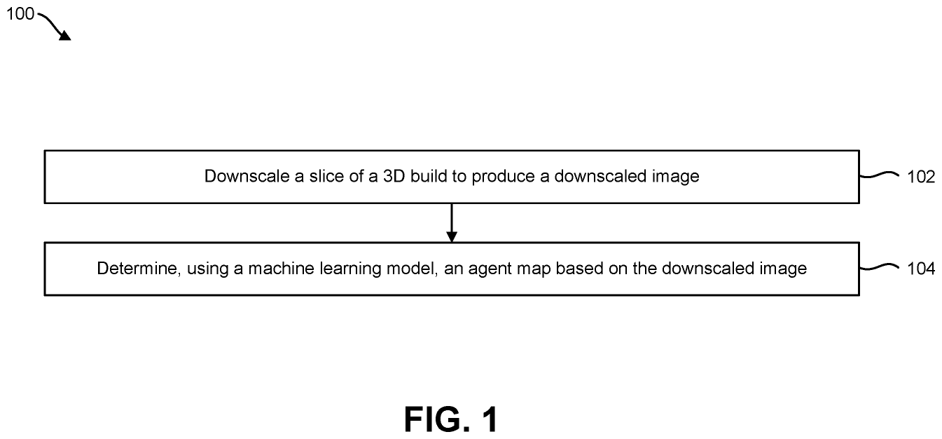

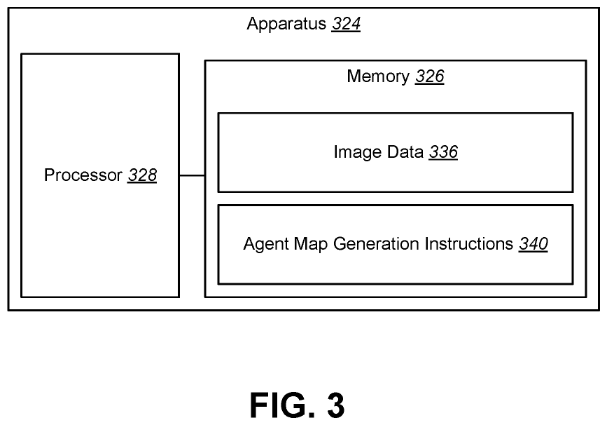

FIG. 1 is a flow diagram illustrating an example of a method 100 for agent map determination. For example, the method 100 may be performed to produce an agent map or agent maps (e.g., fusing agent map and/or detailing agent map). The method 100 and/or an element or elements of the method 100 may be performed by an apparatus (e.g., electronic device). For example, the method 100 may be performed by the apparatus 324 described in relation to FIG. 3.

The apparatus may downscale 102 a slice of a 3D build to produce a downscaled image. For example, the apparatus may down-sample, interpolate (e.g., interpolate using bilinear interpolation, bicubic interpolation, Lanczos kernels, nearest neighbor interpolation, and/or Gaussian kernel, etc.), decimate, filter, average, and/or compress, etc., the slice of a 3D build to produce the downscaled image. For instance, a slice of the 3D build may be an image. In some examples, the slice may have a relatively high resolution (e.g., print resolution and/or 3712×4863 pixels (px), etc.). The apparatus may downscale the slice by removing pixels, performing sliding window averaging on the slice, etc., to produce the downscaled image. In some examples, the slice may be down sampled to an 18.75 DPI image (e.g., 232×304 px). In some examples, the apparatus may downscale 102 multiple slices. For instance, the apparatus may downscale one, some, or all slices corresponding to a build.

In some examples, the apparatus may determine a sequence or sequences of slices, layers, and/or downscaled images. A sequence is a set of slices, layers, and/or downscaled images in order. For instance, a sequence of downscaled images may be a set of downscaled images in a positional (e.g., height, z-axis, etc.) order. For instance, a sequence may have a size (e.g., 10 consecutive slices, layers, and/or downscaled images).

In some examples, the apparatus may determine a lookahead sequence, a current sequence, and/or a lookback sequence. A current sequence may be a sequence at or including a current position (e.g., a current processing position, a current downscaled image, a current slice, and/or a current layer, etc.). A lookahead sequence is a set of slices, layers, and/or downscaled images ahead of (e.g., above) the current sequence (e.g., 10 consecutive slices, layers, and/or downscaled images ahead of the current sequence). A lookback sequence is a set of slices, layers, and/or downscaled images before (e.g., below) the current sequence (e.g., 10 consecutive slices, layers, and/or downscaled images before the current sequence).

The apparatus may determine 104, using a machine learning model, an agent map based on the downscaled image. For example, the downscaled image may be provided to the machine learning model, which may predict and/or infer the agent map. For instance, the machine learning model may be trained to determine (e.g., predict, infer, etc.) an agent map corresponding to the downscaled image. In some examples, the lookahead sequence, the current sequence, and the lookback sequence may be provided to the machine learning model. For instance, the machine learning model may determine 104 the agent map based on the lookahead sequence, the current sequence, and/or the lookback sequence (e.g., 30 downscaled images, layers, and/or slices).

In some examples, the agent map is a fusing agent map. For instance, the agent map may indicate a location or locations where fusing agent is to be applied to enable fusing of material (e.g., powder) to manufacture an object or objects.

In some examples, the agent map is a detailing agent map. For instance, the agent map may indicate a location or location where detailing agent is to be applied to prevent and/or reduce fusing of material (e.g., powder). In some examples, the apparatus may apply a perimeter mask to the detailing agent map to produce a masked detailing agent map. A perimeter mask is a set of data (e.g., an image) with reduced values along a perimeter (e.g., outer edge of the image). For instance, a perimeter mask may include higher values in a central portion and declining values in a perimeter portion of the perimeter mask. The perimeter portion may be a range from the perimeter (e.g., 25 pixels along the outer edge of the image). In the perimeter portion, the values of the perimeter mask may decline in accordance with a function (e.g., linear function, slope, curved function, etc.). In some examples, applying the perimeter mask to the detailing agent map may maintain central values of the detailing agent map while reducing values of the detailing agent map corresponding to the perimeter portion. In some examples, applying the perimeter mask to the detailing agent map may include multiplying (e.g., pixel-wise multiplying) the values of the perimeter mask with the values of the detailing agent map. Applying the perimeter mask to the detailing agent map may produce the masked detailing agent map.

In some examples, the machine learning model may be trained based on a loss function or loss functions. A loss function is a function that indicates a difference, error, and/or loss between a target output (e.g., ground truth) and a machine learning model output (e.g., agent map). For example, a loss function may be utilized to calculate a loss or losses during training. The loss(es) may be utilized to adjust the weights of the machine learning model to reduce and/or eliminate the loss(es). In some cases, a portion of a build may correspond to powder or unfused material. Other portions of a build (e.g., object edges, regions along object edges, etc.) may more significantly affect manufacturing quality. Accordingly, it may be helpful to utilize a loss function or loss functions that produce a loss or losses that focus on (e.g., are weighted towards) object edges and/or regions along object edges. Some examples of the techniques described herein may utilize a masked ground truth image or images to emphasize losses to object edges and/or regions along object edges.

In some examples, the machine learning model is trained based on a masked ground truth image. Examples of ground truth images include ground truth agent maps (e.g., ground truth fusing agent map and/or ground truth detailing agent map). A ground truth agent map is an agent map (e.g., a target agent map determined through computation and/or that is manually determined) that may be used for training. A masked ground truth image (e.g., masked ground truth agent map) is a ground truth image that has had masking (e.g., masking operation(s)) applied. In some examples of the techniques described herein, a masked ground truth image may be determined based on an erosion and/or dilation operation on a ground truth image. For example, a masked ground truth agent map may be determined based on an erosion and/or dilation operation on a ground truth agent map. A dilation operation may enlarge a region from an object edge (e.g., expand an object). An erosion operation may reduce a region from an object edge (e.g., reduce a non-object region around an object). In some examples, a dilation operation may be applied to a ground truth fusing agent map to produce a masked ground truth fusing agent map. In some examples, an erosion operation may be applied to a ground truth detailing agent map to produce a masked ground truth detailing agent map. In some examples, a masked ground truth image may be binarized. For instance, a threshold or thresholds may be applied to the masked ground truth image (e.g., masked ground truth agent map) to binarize the masked ground truth image (e.g., set each pixel to one of two values). For instance, the erosion and/or dilation operation(s) may produce images with a range of pixel intensities (in the masked ground truth image or agent map, for example). A threshold or thresholds may be utilized to set each pixel to a value (e.g., one of two values). For instance, if a pixel intensity of a pixel is greater than or at least a threshold, that pixel value may be set to a ‘1’ or may be set to ‘0’ otherwise.

In some examples, the machine learning model may be trained using a loss function that is based on a masked ground truth agent map or agent maps. For instance, a masked ground truth agent map or agent maps may be a factor or factors in the loss function. In some examples, the loss function may be expressed in accordance with an aspect or aspects of the following approach.

In some examples, IMG_{DA} may denote a predicted detailing agent map, IMG_{FA} may denote a predicted fusing agent map, IMG_{FA-GT} may denote a ground truth fusing agent map, and IMG_{DA-GT} may denote a ground truth detailing agent map, respectively, for a given slice or layer. A masked agent map is denoted with ‘˜’. For example, a masked ground truth fusing agent map is denoted as [symbol] _{FA-GT}. In some examples, the masked ground truth fusing agent map is obtained by applying an image dilation operation with a kernel (e.g., (5,5) kernel). In some examples, the masked ground truth detailing agent map is obtained by subtracting the result of dilation from the result of erosion on a kernel (e.g., (5,5) kernel). In some examples, the agent maps (e.g., images) may have the same dimensions (e.g., x, y dimensions). In some examples, the loss function (e.g., a loss sum) is a weighted addition, where weights may determine the fusing agent versus detailing agent contribution to the overall loss.

An example of the loss function is given in Equation (1).

Loss=w_{ƒ}*(L_{FA}+L_{FA_M})+w_{d}*(L_{DA}+L_{DA_M}) (1)

In Equation (1), L_{FA} is a mean squared error (MSE) between a predicted fusing agent map and a ground truth fusing agent map, L_{FA_M} is an MSE between a masked predicted fusing agent map and a masked ground truth fusing agent map, L_{DA} is an MSE between a predicted detailing agent map and a ground truth detailing agent map, L_{DA_M} is an MSE between a masked predicted detailing agent map and a masked ground truth detailing agent map, w_{ƒ} is a weight (for a fusing agent component of the loss, for instance), w_{d} is a weight (for a detailing agent component loss, for instance), and w_{ƒ}+w_{d}=1. L_{FA} may be a fusion agent loss or loss component, L_{DA} may be a detailing agent loss or loss component, L_{FA_M} may be a masked fusing agent loss or loss component, and/or L_{DA_M} may be a masked detailing agent loss or loss component.

In some examples, L_{FA} may be expressed and/or determined in accordance with Equation (2).

$${L}_{FA} = \frac{1}{n * m} {\sum }_{i = 1}^{n} {\sum }_{j = 1}^{m} {( {p}_{i , j} - {q}_{i , j} )}^{2} , \\ where {p}_{i , j} ∈ {IMG}_{FA} and {q}_{i , j} ∈ {IMG}_{FA - GT} \qquad ( 2 )$$

In some examples, L_{DA} may be expressed and/or determined in accordance with Equation (3).

$${L}_{DA} = \frac{1}{n * m} {\sum }_{i = 1}^{n} {\sum }_{j = 1}^{m} {( {p}_{i , j} - {q}_{i , j} )}^{2} , \\ where {p}_{i , j} ∈ {IMG}_{DA} and {q}_{i , j} ∈ {IMG}_{DA - GT} \qquad ( 3 )$$

In some examples, L_{FA_M} may be expressed and/or determined in accordance with Equation (4).

$${L}_{FA \_ M} = \frac{1}{a} {\sum }_{i = 1}^{n} {\sum }_{j = 1}^{m} {( f ( {p}_{i , j} ) - f ( {q}_{i , j} ) )}^{2} , \\ where {p}_{i , j} ∈ {FA}_{} , {q}_{i , j} ∈ {FA - GT}_{} , \\ f ( {p}_{i , j} ) = \{ \begin{matrix}\begin{matrix}{p}_{i , j} if ( i , j ) ∈ \{ ( k , p ) \vert {p}_{k , p} ∈ {FA - GT}_{} and \\ {p}_{k , p} > {T}_{FA} \}\end{matrix} \\ 0 , otherwise\end{matrix} , \\ and \qquad ( 4 )$$

$$a = \vert \{ ( k , p ) \vert {p}_{k , p} ∈ {FA - GT}_{} and {p}_{k , p} > {T}_{FA} and \\ ( f ( {p}_{k , p} ) - f ( {q}_{k , p} ) ) != 0 ) \} \vert , where a \leq n * m$$

In Equation (4), a denotes a size of a set of pixel coordinates (k, p), such that the pixels coordinates belong to a masked image, the pixel intensity is above a threshold T_{FA}, and a difference of pixel intensity in the predicted image (e.g., predicted fusing agent map) and ground truth image (e.g., fusing agent ground truth agent map) is non-zero. In some examples, averaging may be performed over non-zero difference masked and/or thresholded pixels (without averaging over other pixels, for instance). In some examples, the threshold T_{FA}=20.4 or another value (e.g., 18, 19.5, 20, 21.5, 22, etc.). In some examples, the function ƒ( ) may choose a pixel intensity as 0 or a pixel value (e.g., p_{k,p}, q_{k,p}). For instance, the function ƒ( ) may choose a pixel intensity as 0 or a pixel value based on a ground truth image (e.g., ground truth agent map) with an applied mask (that may be based on the ground truth image, for instance) and the threshold.

In some examples, L_{DA_M} may be expressed and/or determined in accordance with Equation (5).

$${L}_{DA \_ M} = \frac{1}{a} {\sum }_{i = 1}^{n} {\sum }_{j = 1}^{m} {( f ( {p}_{i , j} ) - f ( {q}_{i , j} ) )}^{2} , \\ where {p}_{i , j} ∈ {DA}_{} , {q}_{i , j} ∈ {DA - GT}_{} , \\ f ( {p}_{i , j} ) = \{ \begin{matrix}\begin{matrix}{p}_{i , j} if ( i , j ) ∈ \{ ( k , p ) \vert {p}_{k , p} ∈ {DA - GT}_{} and \\ {p}_{k , p} > {T}_{DA} \}\end{matrix} \\ 0 , otherwise\end{matrix} , \\ and \qquad ( 5 )$$

$$a = \vert \{ ( k , p ) \vert {p}_{k , p} ∈ {DA - GT}_{} and {p}_{k , p} > {T}_{DA} and \\ ( f ( {p}_{k , p} ) - f ( {q}_{k , p} ) ) != 0 ) \} \vert , where a \leq n * m$$

In Equation (5), a denotes a size of a set of pixel coordinates (k, p), such that the pixels coordinates belong to a masked image, the pixel intensity is above a threshold T_{DA}, and a difference of pixel intensity in the predicted image (e.g., predicted detailing agent map) and ground truth image (e.g., detailing agent ground truth agent map) is non-zero. In some examples, averaging may be performed over non-zero difference masked and/or thresholded pixels (without averaging over other pixels, for instance). In some examples, the threshold T_{DA}=20.4 or another value (e.g., 18, 19.5, 20, 21.5, 22, etc.). T_{DA} may be the same as T_{FA} or different. In some examples, the function ƒ( ) may choose a pixel intensity as 0 or a pixel value (e.g., p_{k,p}, q_{k,p}). For instance, the function ƒ( ) may choose a pixel intensity as 0 or a pixel value based on a ground truth image (e.g., ground truth agent map) with an applied mask (that may be based on the ground truth image, for instance) and the threshold.

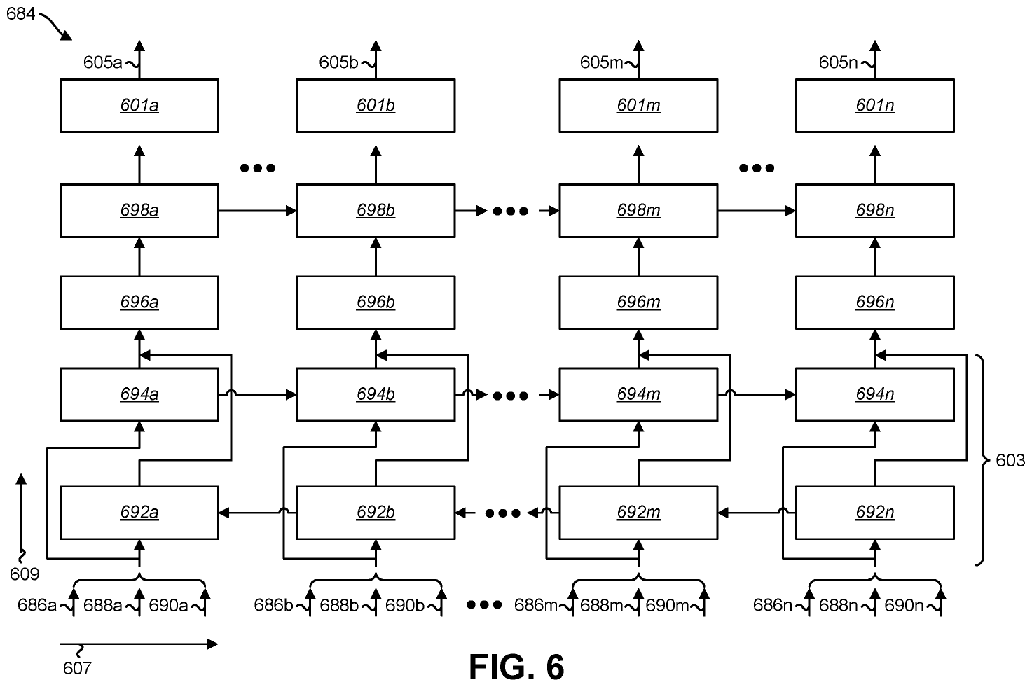

In some examples, the machine learning model may be a bidirectional convolutional recurrent neural network. For instance, the machine learning model may include connected layers in opposite directions. An example of a bidirectional convolutional recurrent neural network is given in FIG. 6. In some examples, a fusing agent map may follow object shapes in a slice. In some examples, a detailing agent map may have a dependency on previous slices or layers and/or upcoming slices or layers. For example, a fusing agent map may be determined where an object shape has a 2-layer offset before the position of the object shape. In some examples, a detailing agent map may be determined with a 3-layer offset after a given object shape appears in slices. Beyond an object shape, the fusing agent application may end, while the detailing agent application may continue for a quantity of slices or layers (e.g., 5, 10, 11, 15, etc.) before ending. In some examples, an offset may span a sequence, may be within a sequence, or may extend beyond a sequence. In some examples, an amount of detailing agent usage may vary with slices or layers. In some examples, an amount of fusing agent usage may vary less. In some examples, an amount of agent (e.g., detailing agent) may vary based on a nearest surface above and/or a nearest surface below a current shape (e.g., object). A nearest surface location may extend beyond a current sequence (e.g., lookahead and/or lookback may be helpful for nearest surface dependencies). In some examples, additional spatial dependencies may determine detailing agent amount (e.g., lowering of detailing agent contone values near the boundary of the build bed and/or on the inside of parts such as holes and corners). In some examples, short-term dependencies (e.g., in-sequence dependencies) and/or long-term dependencies (e.g., out-of-sequence dependencies) may determine contone values for detailing agent and/or fusing agent. In some examples, the machine learning model may model the long-term dependencies, the short-term dependencies, and/or kernel computations to determine the agent map(s) (e.g., contone values).

In some examples, an operation or operations of the method 100 may be repeated to determine multiple agent maps corresponding to multiple slices and/or layers of a build.

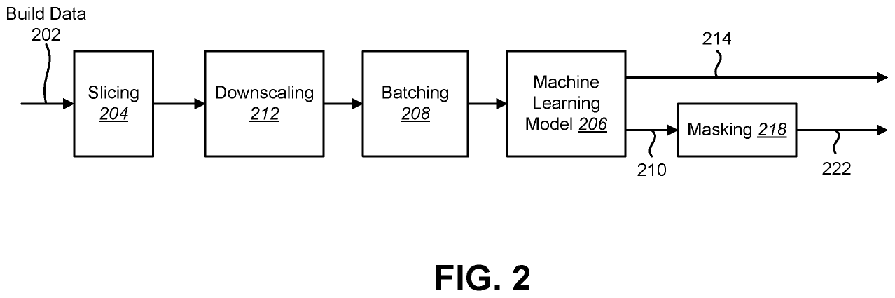

FIG. 2 is a block diagram illustrating examples of functions for agent map generation. In some examples, one, some, or all of the functions described in relation to FIG. 2 may be performed by the apparatus 324 described in relation to FIG. 3. For instance, instructions for slicing 204, downscaling 212, batching 208, a machine learning model 206, and/or masking 218 may be stored in memory and executed by a processor in some examples. In some examples, a function or functions (e.g., slicing 204, downscaling 212, the batching 208, the machine learning model 206, and/or the masking 218, etc.) may be performed by another apparatus. For instance, slicing 204 may be carried out on a separate apparatus and sent to the apparatus.

Build data 202 may be obtained. For example, the build data 202 may be received from another device and/or generated. In some examples, the build data 202 may include and/or indicate geometrical data. Geometrical data is data indicating a model or models of an object or objects. An object model is a geometrical model of an object or objects. An object model may specify shape and/or size of a 3D object or objects. In some examples, an object model may be expressed using polygon meshes and/or coordinate points. For example, an object model may be defined using a format or formats such as a 3D manufacturing format (3MF) file format, an object (OBJ) file format, computer aided design (CAD) file, and/or a stereolithography (STL) file format, etc. In some examples, the geometrical data indicating a model or models may be received from another device and/or generated. For instance, the apparatus may receive a file or files of geometrical data and/or may generate a file or files of geometrical data. In some examples, the apparatus may generate geometrical data with model(s) created on the apparatus from an input or inputs (e.g., scanned object input, user-specified input, etc.).

Slicing 204 may be performed based on the build data 202. For example, slicing 204 may include generating a slice or slices (e.g., 2D slice(s)) corresponding to the build data 202 as described in relation to FIG. 1. For instance, the apparatus (or another device) may slice the build data 202, which may include and/or indicate a 3D model of an object or objects. In some examples, slicing may include generating a set of 2D slices corresponding to the build data 202. In some approaches, the build data 202 may be traversed along an axis (e.g., a vertical axis, z-axis, or other axis), where each slice represents a 2D cross section of the 3D build data 202. For example, slicing the build data 202 may include identifying a z-coordinate of a slice plane. The z-coordinate of the slice plane can be used to traverse the model to identify a portion or portions of the model intercepted by the slice plane. In some examples, a slice may have a size and/or resolution of 3712×4863 px. In some examples, the slice(s) may be provided to the downscaling 212.

The downscaling 212 may produce a downscaled image or images. In some examples, the downscaling 212 may produce the downscaled image(s) based on the build data 202 and/or the slice(s) provided by slicing 204. For example, the downscaling 212 may down-sample, filter, average, decimate, etc. the slice(s) to produce the downscaled image(s) as described in relation to FIG. 1. For instance, the slice(s) may be at print resolution (e.g., 300 DPI or 3712×4863 px) and may be down-sampled to a lower resolution (e.g., 18.75 DPI or 232×304 px). The downscaled image(s) may be reduced-size and/or reduced-resolution versions of the slice(s). In some examples, the downscaled image(s) may have a resolution and/or size of 232×304 px. The downscaled image(s) may be provided to batching 208.

The batching 208 may group the downscaled image(s) into a sequence or sequences, a sample or samples, and/or a batch or batches. For example, a sequence may be a group of down-sampled images (e.g., slices and/or layers). A sample is a group of sequences. For instance, multiple sequences (e.g., in-order sequences) may form a sample. A batch is a group of samples. For example, a batch may include multiple samples. The batching 208 may assemble sequence(s), sample(s), and/or batch(es). In some examples, the batching 208 may sequence and batch the downscaled slices into samples and generate 10-layer lookahead and lookback samples. For instance, lookahead sample batches may have a sample size of 2 and a sequence size of 10, current sample batches may have a sample size of 2 and a sequence size of 10, and/or lookback sample batches may have a sample size of 2 and a sequence size of 10. The sequence(s), sample(s), and/or batch(es) may be provided to the machine learning model 206. For instance, inputs may be passed to the machine learning model 206 as 3 separate channels.

The machine learning model may produce a predicted fusing agent map 214 and a predicted detailing agent map 210 (e.g., unmasked detailing agent map). In some examples, the machine learning model 206 (e.g., deep learning engine) may use a sample as an input to generate agent maps corresponding to a sample. In some examples, the input for the machine learning model 206 includes a 3-channel image and the output of the machine learning model 206 includes a 2-channel image for each time increment. In some examples, the predicted fusing agent map 214 may have a size and/or resolution of 232×304 px. In some examples, the predicted detailing agent map 210 may have a size and/or resolution of 232×304 px. In some examples, the predicted detailing agent map 210 may be provided to the masking 218.

The masking 218 may apply a perimeter mask to the detailing agent map 210. For instance, the masking 218 may apply a perimeter mask (e.g., downscaled perimeter mask) with a size and/or resolution of 232×304 px to the detailing agent map 210. The masking 218 may produce a masked detailing agent map 222. In some examples, the masked detailing agent map 222 may have a size and/or resolution of 232×304 px.

FIG. 3 is a block diagram of an example of an apparatus 324 that may be used in agent map generation. The apparatus 324 may be a computing device, such as a personal computer, a server computer, a printer, a 3D printer, a smartphone, a tablet computer, etc. The apparatus 324 may include and/or may be coupled to a processor 328 and/or a memory 326. In some examples, the apparatus 324 may be in communication with (e.g., coupled to, have a communication link with) an additive manufacturing device (e.g., a 3D printer). In some examples, the apparatus 324 may be an example of 3D printer. The apparatus 324 may include additional components (not shown) and/or some of the components described herein may be removed and/or modified without departing from the scope of the disclosure.

The processor 328 may be any of a central processing unit (CPU), a semiconductor-based microprocessor, graphics processing unit (GPU), field-programmable gate array (FPGA), an application-specific integrated circuit (ASIC), and/or other hardware device suitable for retrieval and execution of instructions stored in the memory 326. The processor 328 may fetch, decode, and/or execute instructions stored on the memory 326. In some examples, the processor 328 may include an electronic circuit or circuits that include electronic components for performing a functionality or functionalities of the instructions. In some examples, the processor 328 may perform one, some, or all of the aspects, elements, techniques, etc., described in relation to one, some, or all of FIGS. 1-7.

The memory 326 is an electronic, magnetic, optical, and/or other physical storage device that contains or stores electronic information (e.g., instructions and/or data). The memory 326 may be, for example, Random Access Memory (RAM), Electrically Erasable Programmable Read-Only Memory (EEPROM), a storage device, an optical disc, and/or the like. In some examples, the memory 326 may be volatile and/or non-volatile memory, such as Dynamic Random Access Memory (DRAM), EEPROM, magnetoresistive random-access memory (MRAM), phase change RAM (PCRAM), memristor, flash memory, and/or the like. In some examples, the memory 326 may be a non-transitory tangible machine-readable storage medium, where the term “non-transitory” does not encompass transitory propagating signals. In some examples, the memory 326 may include multiple devices (e.g., a RAM card and a solid-state drive (SSD)).

In some examples, the apparatus 324 may further include a communication interface through which the processor 328 may communicate with an external device or devices (not shown), for instance, to receive and store the information pertaining to an object or objects of a build or builds. The communication interface may include hardware and/or machine-readable instructions to enable the processor 328 to communicate with the external device or devices. The communication interface may enable a wired or wireless connection to the external device or devices. The communication interface may further include a network interface card and/or may also include hardware and/or machine-readable instructions to enable the processor 328 to communicate with various input and/or output devices, such as a keyboard, a mouse, a display, another apparatus, electronic device, computing device, printer, etc., through which a user may input instructions into the apparatus 324.

In some examples, the memory 326 may store image data 336. The image data 336 may be generated (e.g., predicted, inferred, produced, etc.) and/or may be obtained (e.g., received) from an external device. For example, the processor 328 may execute instructions (not shown in FIG. 3) to obtain object data, build data, slices, and/or layers, etc. In some examples, the apparatus 324 may receive image data 336 (e.g., build data, object data, slices, and/or layers, etc.) from an external device (e.g., external storage, network device, server, etc.).

In some examples, the image data 336 may include a layer image or images. For instance, the memory 326 may store the layer image(s). The layer image(s) may include and/or indicate a slice or slices of a model or models (e.g., 3D object model(s)) in a build volume. For instance, a layer image may indicate a slice of a 3D build. The apparatus 324 may generate the layer image(s) and/or may receive the layer image(s) from another device. In some examples, the memory 326 may include slicing instructions (not shown in FIG. 3). For example, the processor 328 may execute the slicing instructions to perform slicing on the 3D build to produce a stack of slices.

The memory 326 may store agent map generation instructions 340. For example, the agent map generation instructions 340 may be instructions for generating an agent map or agent maps. In some examples, the agent map generation instructions 340 may include data defining and/or implementing a machine learning model or models. In some examples, the machine learning model(s) may include a neural network or neural networks. For instance, the agent map generation instructions 340 may define a node or nodes, a connection or connections between nodes, a network layer or network layers, and/or a neural network or neural networks. In some examples, the machine learning structures described herein may be examples of the machine learning model(s) defined by the agent map generation instructions 340.

In some examples, the processor 328 may execute the agent map generation instructions 340 to generate, using a machine learning model, an agent map based on the layer image(s). For instance, the processor 328 may perform an operation or operations described in relation to FIG. 1 and/or FIG. 2 to produce a fusing agent map and/or a detailing agent map. The agent map(s) may be stored as image data 336 in the memory 326.

In some examples, the processor 328 may execute the agent map generation instructions 340 to determine patches based on a layer image. A patch is image data corresponding to a portion of a layer image. In some examples, a patch may be downscaled relative to the corresponding portion of the layer image. In some examples, the processor 328 may execute the agent map generation instructions 340 to infer agent map patches based on the patches. For example, the processor 328 may execute a machine learning model to infer agent map patches. In some examples, the processor 328 may combine the agent map patches to produce the agent map.

In some examples, patch-based training and/or inferencing may be performed that uses inputs at a higher resolution than other examples herein (e.g., 900×1200 versus 232×304). For instance, some of the techniques described herein may be utilized to generate a fusing agent map and/or detailing agent map at an intermediate resolution. Some of these techniques may be useful for builds that include fine features that may get lost with greater downscaling and/or may avoid fusing agent and detailing agent combinations that may occur in a very low resolution image (18 DPI, 232×304) but do not occur in a higher resolution (e.g., 600 DPI) image. In some examples, original slice images may be downscaled to a resolution (e.g., an intermediate resolution, image size 900×1200, etc.). A stack of patches may be determined based on a downscaled image or images. For example, each patch may have a size of 60×80 px. A machine learning model may be utilized to perform inferences for a stack of patches (e.g., each downscaled image may have 225 corresponding patches) to produce agent map patches. A stack of patches may be a stack in a z direction, where a stack of patches corresponds to a sequence of layers. Agent map patches may be combined (e.g., stitched together) to form a fusing agent map and/or a detailing agent map.

In some examples, individual slice images may have a size of 1800×2400 px. The slice images may be broken into sequences and downscaled to produce sequenced images with a size of 900×1200 px. Patches may be created from the sequenced images, where each patch has a size of 60×80 px. The patches may be provided to a machine learning model to produce predicted patches (e.g., stacks of predicted patches with a size of 60×80 for a fusing agent map and/or for a detailing agent map). The patches may be stitched to produce a stack of images (e.g., predicted fusing agent maps and/or predicted detailing agent maps), each with a size of 900×1200.

In some examples, the processor 328 may execute the agent map generation instructions 340 to perform a rolling window of inferences within a sequence. The rolling window of inferences may provide multiple inferences for a given time increment. For instance, for two 10-layer sequences, a rolling window with a stride of 1 may generate eleven 10-layer sequences (e.g., two sequences of [[1,10], [11,20]] with a rolling window that may generate sequences of [[1,10], [2,11], [3,12], [4,13], [5,14], [6,15], [7,16], [8,17], [9,18], [10,19], [11,20]], where the first and second values in square brackets [ ] may denote the start and end layers of a sequence). In some examples, the processor 328 may utilize a heuristic (e.g., max, most frequent, and/or median, etc.) to choose one of the inferences as an agent map.

In some examples, the memory 326 may store operation instructions (not shown). In some examples, the processor 328 may execute the operation instructions to perform an operation based on the agent map(s). In some examples, the processor 328 may execute the operation instructions to utilize the agent map(s) to serve another device (e.g., printer controller). For instance, the processor 328 may print (e.g., control amount and/or location of agent(s) for) a layer or layers based on the agent map(s). In some examples, the processor 328 may drive model setting (e.g., the size of the stride) based on the agent map(s). In some examples, the processor 328 may feed the agent map for the upcoming layer to a thermal feedback control system to online compensate for an upcoming layer.

In some examples, the operation instructions may include 3D printing instructions. For instance, the processor 328 may execute the 3D printing instructions to print a 3D object or objects. In some examples, the 3D printing instructions may include instructions for controlling a device or devices (e.g., rollers, nozzles, print heads, thermal projectors, and/or fuse lamps, etc.). For example, the 3D printing instructions may use the agent map(s) to control a print head or heads to print an agent or agents in a location or locations specified by the agent map(s). In some examples, the processor 328 may execute the 3D printing instructions to print a layer or layers. In some examples, the processor 328 may execute the operation instructions to present a visualization or visualizations of the agent map(s) on a display and/or send the agent map(s) to another device (e.g., computing device, monitor, etc.).

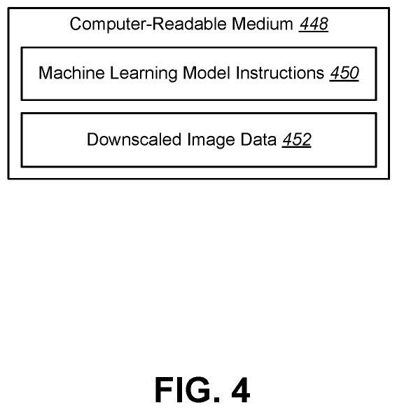

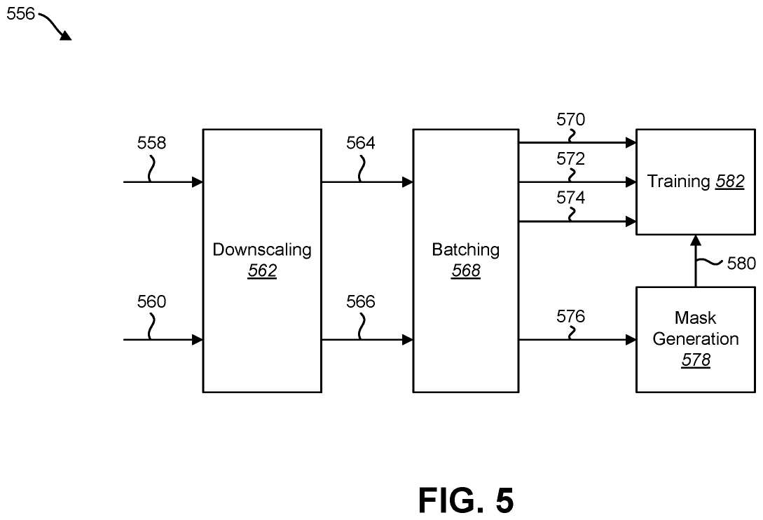

FIG. 4 is a block diagram illustrating an example of a computer-readable medium 448 for agent map generation. The computer-readable medium 448 is a non-transitory, tangible computer-readable medium. The computer-readable medium 448 may be, for example, RAM, EEPROM, a storage device, an optical disc, and the like. In some examples, the computer-readable medium 448 may be volatile and/or non-volatile memory, such as DRAM, EEPROM, MRAM, PCRAM, memristor, flash memory, and the like. In some examples, the memory 326 described in relation to FIG. 3 may be an example of the computer-readable medium 448 described in relation to FIG. 4. In some examples, the computer-readable medium may include code, instructions and/or data to cause a processor perform one, some, or all of the operations, aspects, elements, etc., described in relation to one, some, or all of FIG. 1, FIG. 2, FIG. 3, FIG. 5, and/or FIG. 6.

The computer-readable medium 448 may include code (e.g., data, executable code, and/or instructions). For example, the computer-readable medium 448 may include machine learning model instructions 450 and/or downscaled image data 452.

The machine learning model instructions 450 may include code to cause a processor to generate (e.g., predict), using a machine learning model, an agent map based on a downscaled image of a slice of a 3D build. For instance, the machine learning model instructions 450 may include code to cause a processor to generate a predicted agent map (e.g., a predicted fusing agent map and/or a predicted detailing agent map). Generating the agent map may be based on downscaled image data 452 (e.g., a downscaled image or images corresponding to a slice or slices of a 3D build). The downscaled image data 452 may be produced by the processor and/or received from another device. In some examples, downscaled image data may not be stored on the computer-readable medium (e.g., downscaled image data may be provided by another device or storage device). In some examples, using a machine learning model to generate the agent map(s) may be performed as described in relation to FIG. 1, FIG. 2, and FIG. 3. Agent map generation may be performed during inferencing and/or training.

In some examples, the computer-readable medium 448 may include training instructions. The training instructions may include code to cause a processor to determine a loss (e.g., a loss based on a predicted agent map and a ground truth agent map). In some examples, determining a loss may be performed as described in relation to FIG. 1. For instance, the code to cause the processor to determine a loss may include code to cause the processor to determine a detailing agent loss component and a fusing agent loss component. In some examples, the code to cause the processor to determine the loss may include code to cause the processor to determine the loss based on a masked predicted detailing agent map and a masked predicted fusing agent map.

The training instructions may include code to cause the processor to train a machine learning model based on the loss. In some examples, training the machine learning model based on the loss may be performed as described in relation to FIG. 1. For instance, the processor may adjust weight(s) of the machine learning model to reduce the loss. In some examples, the computer-readable medium 448 may not include training instructions. For instance, the machine learning model may be trained separately and/or the trained machine learning model may be stored in the machine learning model instructions 450.

In some examples, ground truth agent maps may be generated. In some examples, a perimeter mask may be applied to a detailing agent map. The perimeter mask may be a static mask (e.g., may not change with shape). In some examples, ground truth agent maps may be expressed as images without a perimeter mask. While generating ground truth agent maps, the perimeter mask may not be applied in some approaches. For instance, unmasked detailing agent maps may be produced.

Table (1) illustrates different stages with corresponding input datasets and outputs for some examples of the machine learning models described herein.

TABLE 1

| Stage | Input Dataset | Output |
|---|---|---|
| Training | Downscaled slice and ground | Predicted agent maps (e.g., |
| and/or | truth agent maps (e.g., ground | predicted fusing agent maps |
| Testing | truth fusing agent maps and | and (unmasked) predicted |
| | ground truth detailing agent | detailing agent maps) (image |
| | maps) | same size as input) |
| Inferencing | Downscaled slices | Predicted agent maps (e.g., |
| | | predicted fusing agent maps |
| | | and predicted detailing agent |
| | | maps) (image same size as |
| | | input) |
| Detailing | Downscaled perimeter mask, | Masked predicted detailing |
| Mask | unmasked predicted detailing | agent maps |
| Processing | agent maps | |

FIG. 5 is a diagram illustrating an example of training 556. The training 556 may be utilized to train a machine learning model or models described herein. As illustrated in FIG. 5, slice images 558 and agent maps 560 may be downscaled and batched. For example, slice images 558 (with a resolution of 3712×4863 px, for instance) may be provided to a downscaling 562 function, which may produce downscaled slices 564 (with a resolution of 232×304 px, for instance). The downscaled slices 564 may be provided to a batching 568 function. In some examples, the batching 568 may sequence and batch the downscaled slices 564 into sequences, samples, and/or batches. For instance, the batching 568 may produce a lookahead sequence 570, a current sequence 572, and/or lookback sequence 574. In some examples, lookahead sample batches may have a sample size of 2 and a sequence size of 10, current sample batches may have a sample size of 2 and a sequence size of and/or lookback sample batches may have a sample size of 2 and a sequence size of 10. The batched slice images 570, 572, 574 may be provided to training 582.

In some examples, agent maps 560 (with a resolution of 3712×4863 px, for instance) may be provided to the downscaling 562 function, which may produce (unmasked, for example) downscaled ground truth agent maps 566 (with a resolution of 232×304 px, for instance). For instance, ground truth fusing agent maps and/or ground truth detailing agent maps may be provided to the downscaling 562 to produce unmasked downscaled ground truth fusing agent maps and/or unmasked downscaled ground truth detailing agent maps. The downscaled ground truth agent maps 566 may be provided to the batching 568 function. In some examples, the batching 568 may sequence and batch the downscaled ground truth agent maps 566 into sequences, samples, and/or batches. For instance, the batching 568 may produce batched agent maps 576. In some examples, batched agent maps 576 may have a sample size of 2 and a sequence size of 10. The batched agent maps 576 may be provided to a mask generation 578 function.

For example, the batched agent maps 576 may be utilized to determine masks 580 for loss computation. For instance, masks 580 may be generated for training 582. For instance, the masks 580 may be generated from the (ground truth) batched agent maps 576 (e.g., downscaled ground truth fusing agent maps and/or downscaled ground truth detailing agent maps) using an erosion and/or dilation operation. The masks 580 (e.g., masked ground truth agent map(s), masked ground truth fusing agent map(s), masked ground truth detailing agent map(s)) may be generated to weigh object and object-powder interface pixels higher in the loss computations as a relatively large proportion (e.g., 70%, 80%, 90%, etc.) of pixels may correspond to powder (e.g., non-object pixels). The masks 580 may be different from the perimeter mask described herein. For inferencing, for example, a perimeter mask may be applied to a predicted detailing agent map. In some examples, the perimeter mask may be applied uniformly to all layers and/or may be independent of object shape in a slice. The masks 580 for the loss computation may depend on object shape.

The masks 580 may be provided to training 582. The training 582 may train a machine learning model based on the batched slice images 570, 572, 574 and the masks 580. For instance, the training 582 may compute a loss based on the masks 580, which may be utilized to train the machine learning model.

FIG. 6 is a diagram illustrating an example of a machine learning model architecture 684. The machine learning model architecture 684 described in connection with FIG. 6 may be an example of the machine learning model(s) described in relation to one, some or all of FIGS. 1-5. In this example, layers corresponding to a batch are provided to the machine learning model structures to produce fusing agent maps and detailing agent maps in accordance with some of the techniques described herein.

In the machine learning architecture 684, convolutions capture spatial relationships amongst the pixels and multiple layers form a hierarchy of abstractions based on individual pixels. Features may accordingly be represented using stacks of convolutions. LSTM neural networks (e.g., a variant of a recurrent neural network), with gating functions to control memory and hidden state, may be used to capture temporal relationships without the vanishing gradient difficulties of some recurrent neural networks. Combining stacks of convolutions and LSTMs together may model some spatio-temporal dependencies. In some examples, 2D convolutional LSTM neural networks may be utilized. The diagram of FIG. 6 illustrates increasing model depth 609 from the bottom of the diagram to the top of the diagram, and increasing time 607 from the left of the diagram to the right of the diagram.

In the example of FIG. 6, the machine learning model architecture 684 includes model layers of 2D convolutional LSTM neural networks 692a-n, 694a-n, 698a-n, a batch normalization model layer or layers 696a-n, and a model layer of 3D convolutional neural networks 601a-n. The machine learning model architecture 684 model takes three sequences (e.g., a lookback sequence 686a-n, a current sequence 688a-n, and a lookahead sequence 690a-n) as input. For example, a lookback sequence 686a-n may include slices for layers 1-10 of a batch, a current sequence 688a-n may include slices for layers 11-20 of the batch, and a lookahead sequence 690a-n may include slices for layers 21-30 of the batch. Respective slices may be input to respective columns of the machine learning model architecture 684 of FIG. 6. An agent map or maps (e.g., predicted fusing agent map and/or detailing agent map) may be outputted and fed to subsequent model layers as inputs. Each sequence may be unfolded one layer at a time.

At a first model layer of 2D convolutional LSTM networks 692a-n and/or a second model layer of 2D convolutional LSTM networks 694a-n, a bi-directional wrapper 603 may be utilized to account for dependencies from front to back and back to front within a sequence. Batch normalization 696a-n may be performed on the outputs of the first model layer of 2D convolutional LSTM networks 692a-n and/or second model layer of 2D convolutional LSTM networks 694a-n. The outputs of the batch normalization 696a-n may be provided to a third model layer of 2D convolutional LSTM networks 698a-n. Outputs of the third model layer of 2D convolutional LSTM networks 698a-n may be provided to a model layer of 3D convolutional networks 601a-n. In some examples, a different number (e.g., additional) model layers may be utilized between the third model layer of 2D convolutional LSTM networks 698a-n and the model layer of 3D convolutional networks 601a-n. The layer of 3D convolutional networks 601a-n may provide predicted agent maps 605a-n (e.g., predicted fusing agent maps and/or detailing agent maps). Lookback and lookahead in the machine learning model architecture 684 may provide context for out-of-sequence dependencies.

In some examples, the quantity of layers may be tuned for GPU memory. For example, kernels used in convolutions and a quantity of layers may be tuned for agent map prediction and/or available GPU memory.

In some examples, the loss function for the machine learning model architecture 684 may be a sum of mean square error (MSE) of agent maps (e.g., fusing agent map and detailing agent map) together with the MSE of the masked agent maps (e.g., masked fusing agent map and masked detailing agent map). In some examples, the mask (e.g., masked agent map) may be derived from the ground truth fusing agent map and detailing agent map. In some approaches, the masked ground truth fusing agent map and masked ground truth detailing agent map (e.g., contone images) are not binary, and thresholds (e.g., T_{FA} and T_{DA}, respectively) may be utilized to threshold the masked fusing agent map and/or the masked detailing agent map. In some examples, the thresholds may be derived experimentally.

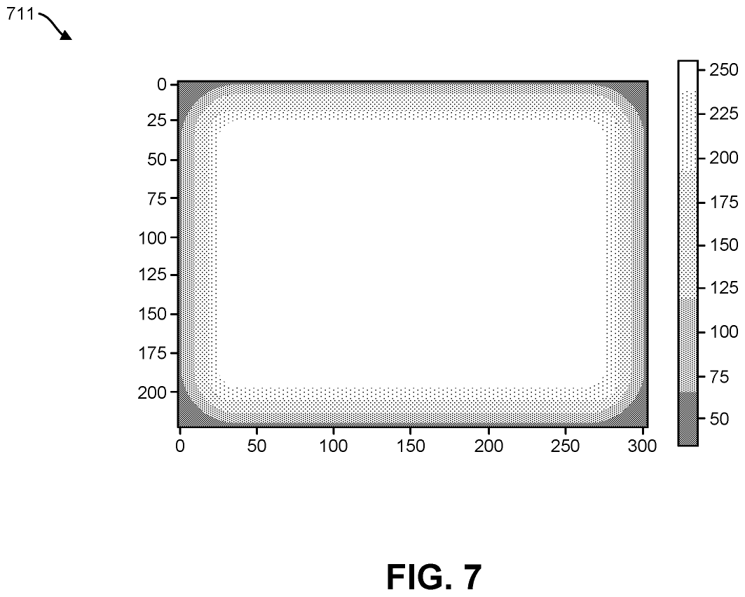

FIG. 7 is a diagram illustrating an example of a perimeter mask 711 in accordance with some of the techniques described herein. The axes of the perimeter mask 711 are given in pixels (e.g., 232×304 px). The degree of the perimeter mask ranges in value from 0 to 255 in this example. The perimeter mask 711 may be multiplied with a predicted detailing agent map to produce a masked detailing agent map in accordance with some of the techniques described herein. For instance, the resulting agent map may be given in the formula: Result=(PredictedDetailingAgentMap*PerimeterMask)/255.

Some examples of the techniques described herein may utilize a deep-learning-based machine learning model. For instance, the machine learning model may have a bidirectional convolutional recurrent neural network-based deep learning architecture. In some examples, ground truth agent maps (e.g., ground truth fusing agent images and/or ground truth detailing agent images) may be utilized to produce masks by applying erosion and/or dilation operations. In some examples, experimentally derived thresholds may be used to binarize the masks. Some examples may apply a perimeter mask (e.g., detailing agent perimeter mask) during inferencing. Some examples may generate an unmasked agent map (e.g., detailing agent map) during training. Some examples may include patch-based inferencing with a rolling window for more accurate contone maps (e.g., fusing agent contone maps and/or detailing agent contone maps).

In some examples of the techniques described herein, a machine learning model may be utilized to predict both a fusing agent map and a detailing agent map in approximately 10 ms per layer. For instance, agent maps of a build volume may be generated in approximately 6 minutes, including loading and writing the images to storage (e.g., disk).

Some approaches to agent map generation may use kernels, lookup tables, and/or per pixel/layer computations to create agent maps for printing. For instance, ground truth agent maps may be computed using kernels, lookup tables, and/or per pixel/layer computations. Some examples of operations may be devoted to evaluating a quantity of layers up and down from the current layer to determine the nearest surface voxel in the z direction (below or above). Some examples of operations may be utilized to ascertain an amount of heat needed for a given object based on black pixel density. Some examples of operations may include arithmetic operators or convolutions on other planes. Some examples of operations may identify small features in a shape such as holes and corners to determine the detailing agent amount. Some examples of operations may include kernel operations used to mimic heat diffusion in and/or around a given object. Some examples of the machine learning models described herein may learn agent map generation operations, which may be performed in parallel using a GPU. Some examples of the techniques described herein may include devices to generate agent maps. Some examples of the techniques described herein may preserve an increased amount of material (e.g., powder) for re-use.

As used herein, the term “and/or” may mean an item or items. For example, the phrase “A, B, and/or C” may mean any of: A (without B and C), B (without A and C), C (without A and B), A and B (but not C), B and C (but not A), A and C (but not B), or all of A, B, and C.

While various examples are described herein, the disclosure is not limited to the examples. Variations of the examples described herein may be implemented within the scope of the disclosure. For example, aspects or elements of the examples described herein may be omitted or combined.

1. A method, comprising:
downscaling a slice of a three-dimensional (3D) build to produce a downscaled image; and
determining, using a machine learning model, an agent map based on the downscaled image.

2. The method of claim 1, further comprising determining a lookahead sequence, a current sequence, and a lookback sequence, wherein determining the agent map is based on the lookahead sequence, the current sequence, and the lookback sequence.

3. The method of claim 1, wherein the agent map is a fusing agent map.

4. The method of claim 1, wherein the agent map is a detailing agent map.

5. The method of claim 4, further comprising applying a perimeter mask to the detailing agent map to produce a masked detailing agent map.

6. The method of claim 1, wherein the machine learning model is trained based on a masked ground truth agent map.

7. The method of claim 6, wherein the masked ground truth agent map is determined based on an erosion or dilation operation on a ground truth agent map, and wherein the method further comprises binarizing the masked ground truth agent map.

8. The method of claim 6, wherein the machine learning model is trained using a loss function that is based on the masked ground truth agent map.

9. The method of claim 1, wherein the machine learning model is a bidirectional convolutional recurrent neural network.

10. An apparatus, comprising:
a memory to store a layer image; and
a processor coupled to the memory, wherein the processor is to generate, using a machine learning model, an agent map based on the layer image.

11. The apparatus of claim 10, wherein the processor is to:
determine patches based on the layer image;
infer agent map patches based on the patches; and
combine the agent map patches to produce the agent map.

12. The apparatus of claim 10, wherein the processor is to:
perform a rolling window of inferences; and
utilize a heuristic to choose one of the inferences as the agent map.

13. A non-transitory tangible computer-readable medium storing executable code, comprising:
code to cause a processor to generate, using a machine learning model, an agent map based on a downscaled image of a slice of a three-dimensional (3D) build.

14. The computer-readable medium of claim 13, further comprising code to cause the processor to determine a loss based on a predicted agent map and a ground truth agent map, comprising code to cause the processor to determine a detailing agent loss component and a fusing agent loss component.

15. The computer-readable medium of claim 13, further comprising:
code to cause the processor to determine a loss based on a masked predicted detailing agent map and a masked predicted fusing agent map; and
code to cause the processor to train a machine learning model based on the loss.
